(19) United States
(12) Patent Application Publication
(10) Pub. No.: US 2026/0192641 A1
(43) Pub. Date: Jul. 9, 2026

(54) TONNEAU COVER ASSEMBLY

(71) Applicant: Michael Paul Govreau, Glen Carbon, IL (US)

(72) Inventor: Michael Paul Govreau, Glen Carbon, IL (US)

(21) Appl. No.: 19/014,974

(22) Filed: Jan. 9, 2025

(51) Int. Cl. B60J 7/10

(52) U.S. Cl. CPC B60J 7/102

(57) ABSTRACT

A tonneau cover assembly includes a frame and a tonneau cover. The frame is mountable on side walls of a truck bed adjacent a lip of each of the side walls. The frame is designed to extend across and over a floor of the truck bed. The tonneau cover is detachably connected to and supported by the frame. The tonneau cover is designed to extend across and over the floor of the truck bed. The tonneau cover includes an opening in a central section of the tonneau cover. The opening is designed to be aligned with a vertical hitch projecting up from the truck bed such that the vertical hitch is connectable to a trailer device.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention

The disclosure relates to tonneau covers for truck beds and more particularly pertains to a new tonneau cover assembly for use with vertical hitches projecting out of the truck bed. Vertical hitches, such as gooseneck hitches and fifth wheel hitches, can be mounted in a pickup truck bed for transport of trailers and recreational vehicles. Tonneau covers are plates or flexible tarps that can be placed at lips of side walls of a truck bed to cover the truck bed and any items stored in the truck bed. Since the vertical hitches project out to connect with the trailer, a tonneau cover cannot be used. The new tonneau cover assembly includes a cover supported on a frame mounted on the side walls of the truck bed, which cover has an opening through which the vertical hitch can be connected to the trailer, so that the truck bed and any items therein can be covered while towing the trailer.

### (2) Description of Related Art Including Information Disclosed Under 37 CFR 1.97 and 1.98

The prior art relates to tonneau covers for truck beds. The prior art, as best understood, does not disclose a tonneau cover assembly that has a gap for use with fifth wheel trailer hitches having a gooseneck hitch projecting out of the truck bed.

### (H) BRIEF SUMMARY OF THE INVENTION

An embodiment of the disclosure meets the needs presented above in a tonneau cover assembly generally comprising a frame and a tonneau cover. The frame is mountable on side walls of a truck bed adjacent a lip of each of the side walls. The frame is designed to extend across and over a floor of the truck bed. The tonneau cover is detachably connected to and supported by the frame. The tonneau cover is designed to extend across and over the floor of the truck bed. The tonneau cover includes an opening in a central section of the tonneau cover. The opening is designed to be aligned with a vertical hitch projecting up from the truck bed such that the vertical hitch is connectable to a trailer device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a tonneau cover assembly according to an embodiment of the disclosure.

FIG. 2 is a top view of a component of an embodiment of the disclosure

FIG. 3 is a perspective view of the component of an embodiment of the disclosure in FIG. 2.

FIG. 4 is a perspective view of a component of an embodiment of the disclosure.

FIG. 5 is a cross-sectional view of an embodiment of the disclosure in use.

FIG. 6 is a perspective view of an embodiment of the disclosure in use.

FIG. 7 is a perspective view of an embodiment of the disclosure in use.

### (J) DETAILED DESCRIPTION OF THE INVENTION

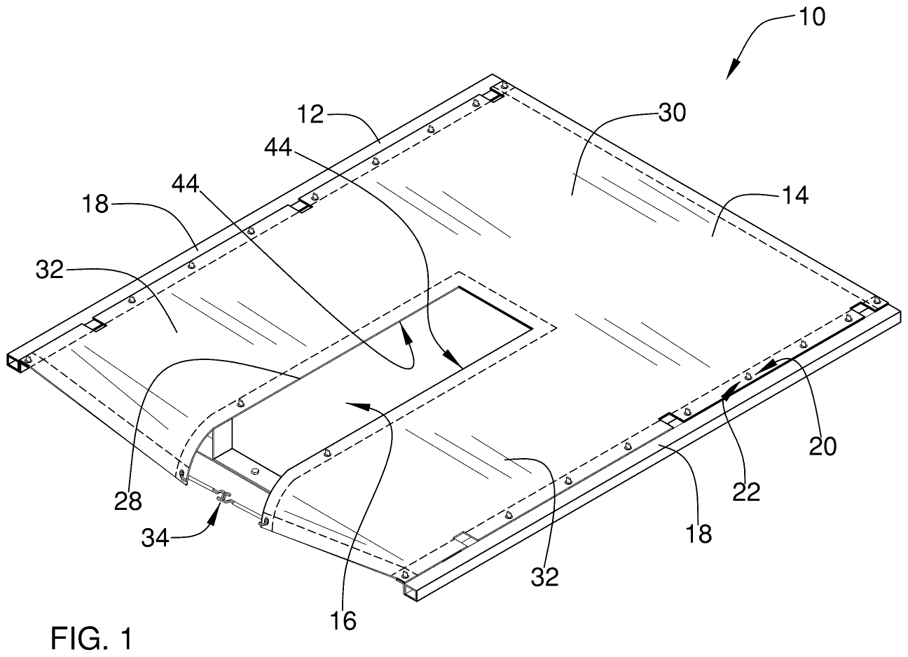

With reference now to the drawings, and in particular to FIGS. 1 through 7 thereof, a new tonneau cover assembly embodying the principles and concepts of an embodiment of the disclosure and generally designated by the reference numeral 10 will be described.

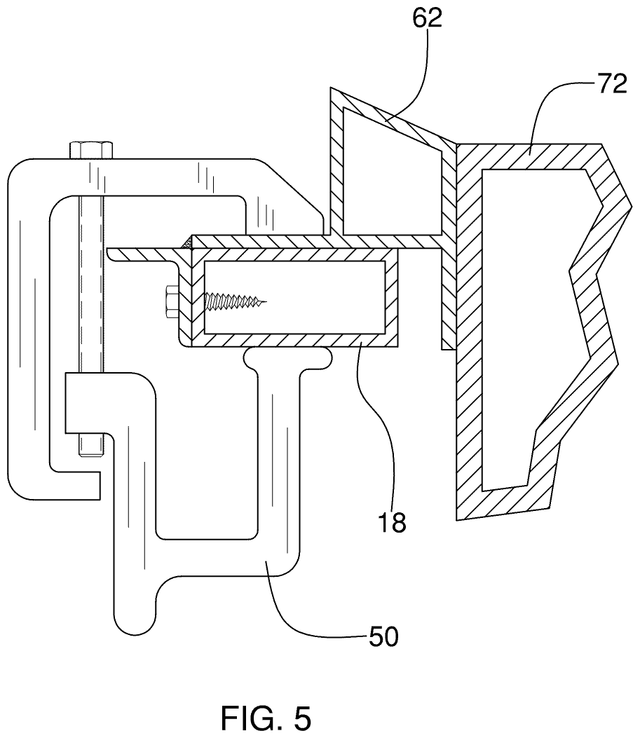

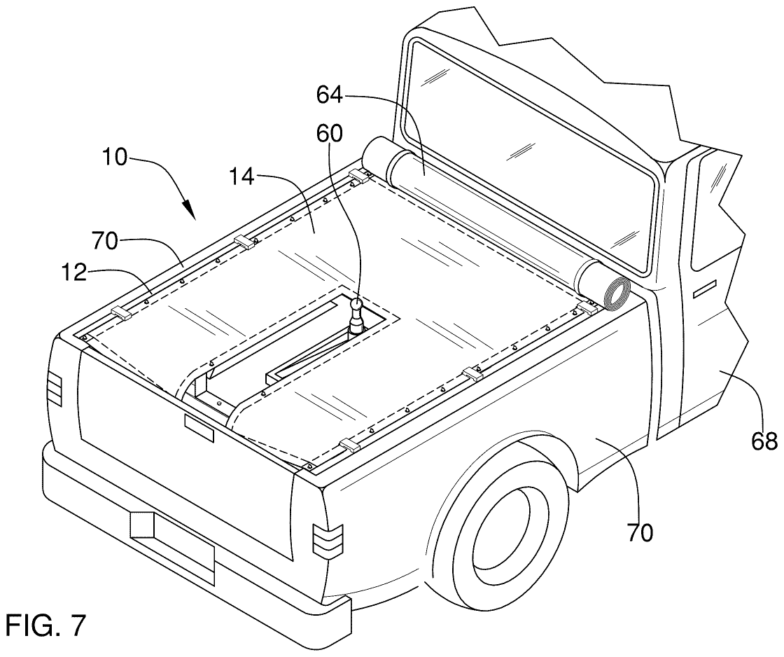

As best illustrated in FIGS. 1 through 7, the tonneau cover assembly 10 generally comprises a frame 12 and a tonneau cover 14. The frame 12 is mountable on side walls 72 of a truck bed 70 adjacent a lip of each of the side walls 72, as shown in FIGS. 5 through 7. The frame 12 is designed to extend across and over a floor 74 of the truck bed 70. The tonneau cover 14 is detachably connected to and supported by the frame 12. The tonneau cover 14 is designed to extend across and over the floor 74 of the truck bed 70. As shown in FIG. 1, the tonneau cover 14 includes an opening 16 in a central section of the tonneau cover 14. As shown in FIG. 7, the opening 16 is designed to be aligned with a vertical hitch 60 projecting up from the truck bed 70 such that the vertical hitch 60 is connectable to a trailer device, such as, for example, a tow trailer or a recreational vehicle.

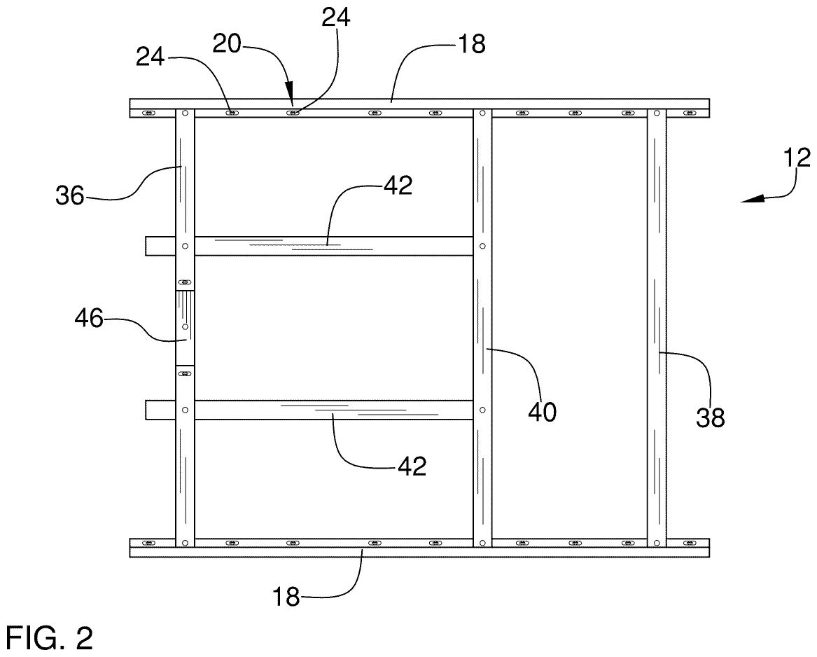

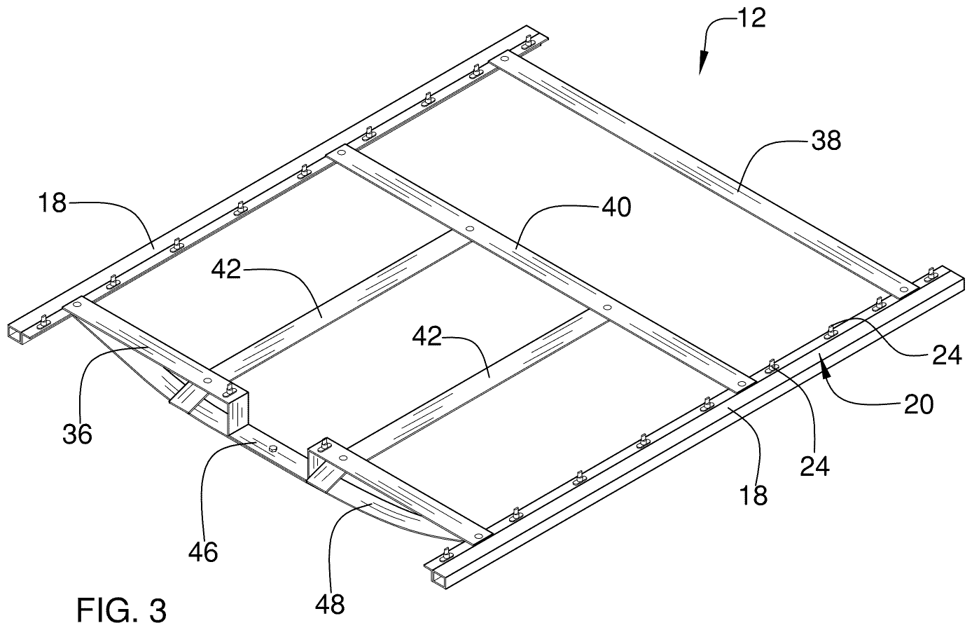

As shown in FIGS. 2 and 3, the frame 12 includes a pair of side pieces 18 designed to be mounted on the side walls 72 of the truck bed 70. The side pieces 18 could be tubes or rails or bands made of metal, such as steel or aluminum, or plastic, such as a hard plastic.

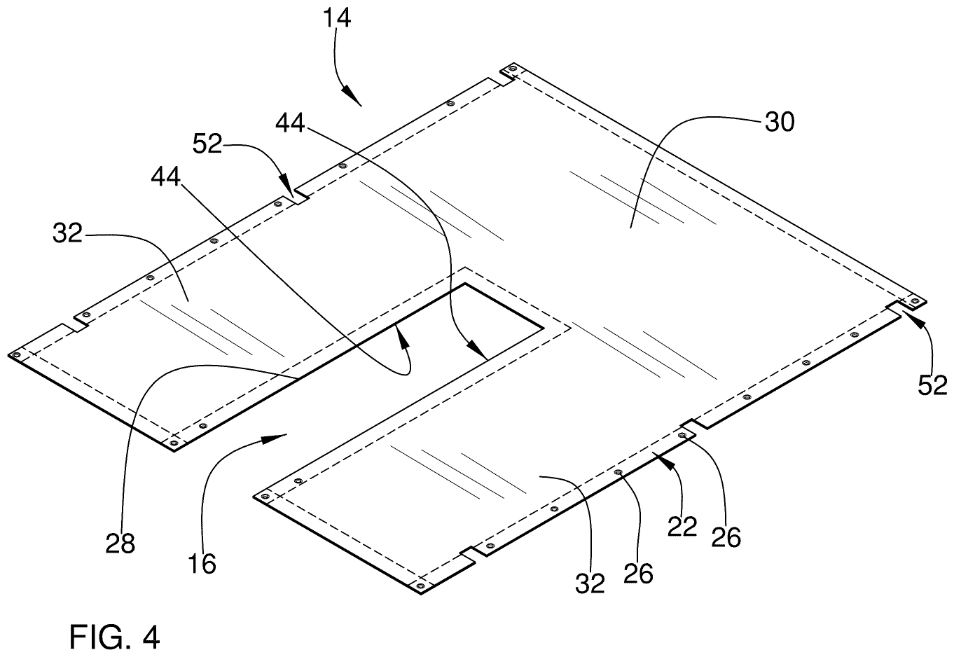

A first mating assembly 20 is positioned on the frame 12 and a second mating assembly 22 is positioned on the tonneau cover 14. The first mating assembly 20 is detachably connected to the second mating assembly 22. In the exemplary embodiment in FIGS. 2 and 3, the first mating assembly 20 is positioned on the side pieces 18. The first mating assembly 20 includes a plurality of projections 24 in the form of twist locks projecting out of each of the side pieces 18, though other types of projections 24 could be used such as posts or tabs. The second mating assembly 22 is positioned on side edges of the tonneau cover 14. In the exemplary embodiment in FIG. 4, the second mating assembly 22 includes a plurality of apertures 26 in the tonneau cover 14. The projections 24 on the side pieces 18 are designed to be inserted through the apertures 26 in the tonneau cover 14 to releasably attached the tonneau cover 14 to the frame 12. The apertures 26 could be grommets or holes formed by stitching. The design of the first mating assembly 20 and the second mating assembly 22 as shown in the figures is only one exemplary embodiment. For example, other types of connections, such as buttons, clasps, zippers, and hook-and-loop material could be used.

In the exemplary embodiment in FIG. 4, the opening 16 in the tonneau cover 14 is an open slot 28 extending from the central section to a rear edge of the tonneau cover 14 to permit selective adjustment of a position of the vertical hitch 60 in the truck bed 70, such that the tonneau cover 14 includes a base portion 30 and two leg portions 32 divided by the open slot 28. In one possible embodiment, the opening 16 in the tonneau cover 14 could be a closed slot, wherein the two leg portions 32 would be connected by a web of material. However, in the exemplary embodiment, the two leg portions 32 are free and could therefore flap in the wind, so a cable 34 can be used to connect end corners of the two leg portions 32, such as the resilient cords shown in FIG. 1.

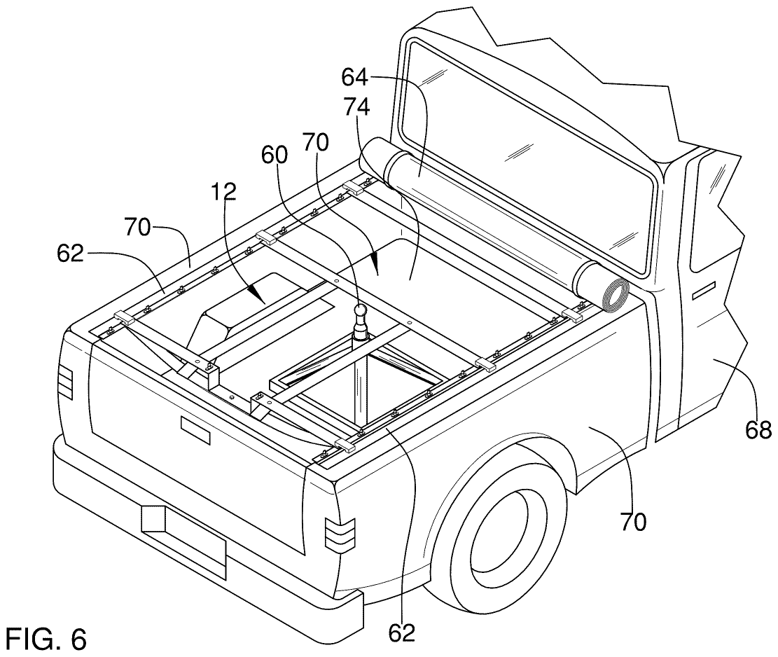

As shown in FIGS. 2 and 3, the frame 12 includes a first cross piece 36 and a second cross piece 38 positioned perpendicular to and connecting the side pieces 18 at respective ends of the side pieces 18. As shown in FIG. 6, the first cross piece 36 is positionable adjacent a rear of the truck bed 70 and the second cross piece 38 is positionable adjacent a front of the truck bed 70. The first cross piece 36 and the second cross piece 38 are designed to support the tonneau cover 14.

In the exemplary embodiment, the frame 12 includes a third cross piece 40 positioned perpendicular to and connecting the side pieces 18 at a middle portion of each of the side pieces 18. The frame 12 includes a pair of support pieces 42 extending perpendicularly from the third cross piece 40 to the first cross piece 36, such that the opening 16 in the tonneau cover 14 is positioned between the support pieces 42. The support pieces 42 can be positioned to run along and support interior edges 44 of the leg portions 32 of the tonneau cover 14 along the open slot 28. The interior edges 44 could be secured to the support pieces 42 in a similar manner as the first mating assembly 20 and the second mating assembly 22.

As shown in FIG. 3, the first cross piece 36 includes a bent center portion 46 positioned between the support pieces 42. The bent center portion 46 has a rectangular profile. The frame 12 includes a support band 48 connected to the side pieces 18 and extending under and connected to the first cross piece 36 at the bent center portion 46. This design provides additional support and stability to the frame 12. The first cross piece 36, the second cross piece 38, the third cross piece 40, and the support pieces 42 could be designed as flat bands as shown in the figures, or could possibly be tubes or rails, made of metal, such as steel or aluminum, or plastic, such as a hard plastic.

The tonneau cover 14 is flexible and designed to be rolled up when not use. However, in one possible embodiment, the tonneau cover 14 could be made of a single rigid panel or a plurality of rigid panels connected together, as is well known in the trucking arts.

The tonneau cover assembly 10 can be used with new trucks or could be installed on trucks having an existing tonneau cover 14. For example, in FIG. 5 the side piece 18 is clamped onto an existing tonneau rail 62 already mounted to the side walls 72 of the truck bed 70. A C-shaped clamp 50 is used to secure the side piece 18 of the frame 12. FIG. 7 shows multiple C-shaped clamps 50 connected to the existing tonneau rails 62 and projecting out through notches 52 in the tonneau cover 14, which notches 52 are best seen in FIG. 4. However, in other possible embodiments, the frame 12 could be connected to the existing tonneau rails 62 by other types of clamps, straps, clasps, or similar devices. Alternatively, the frame 12 could be designed to connect directly to the side walls 72 of the truck bed 70, such as via new tonneau rails, or by connecting devices, such as clamps or screws, or by permanent attachment, such as being formed integrally with the truck bed 70 or attachment by welding. As long as the frame 12 of the tonneau cover assembly 10 is secured, virtually any connection well known in the mechanical arts could be used.

That being said, FIGS. 6 and 7 show the use of the tonneau cover assembly 10 in a truck 68 that already has existing tonneau rails 62 and a cover 64 that is rolled up. Once the frame 12 is installed as shown in FIG. 6, the tonneau cover 14 is placed onto the frame 12 as shown in FIG. 7. The projections 24 are passed through the respective apertures 26 of the tonneau cover 14 to secure the tonneau cover 14 in place. The two leg portions 32 of the tonneau cover 14 could be further secured as discussed herein. The vertical hitch 60, in this case a fifth wheel hitch, is accessible through the open slot 28, and can be positioned as desired along the length of the open slot 28. A trailer or recreational vehicle can now be connected to the vertical hitch 60 with the truck bed 70 mostly covered by the tonneau cover 14, which allows the user to store items securely in the truck bed 70.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A tonneau cover assembly comprising:
a frame being mountable on side walls of a truck bed adjacent a lip of each of the side walls, said frame being configured to extend across and over a floor of the truck bed; and
a tonneau cover being detachably connected to and supported by said frame, said tonneau cover being configured to extend across and over the floor of the truck bed, said tonneau cover including an opening in a central section of said tonneau cover, said opening being configured to be aligned with a vertical hitch projecting up from the truck bed such that the vertical hitch is connectable to a trailer device.

2. The tonneau cover assembly of claim 1, further including a first mating assembly being positioned on said frame and a second mating assembly being positioned on said tonneau cover, said first mating assembly being detachably connected to said second mating assembly.

3. The tonneau cover assembly of claim 2, wherein:
said frame includes a pair of side pieces configured to be mounted on the side walls of the truck bed;
said first mating assembly is positioned on said side pieces; and
said second mating assembly is positioned on side edges of said tonneau cover.

4. The tonneau cover assembly of claim 3, wherein:
said first mating assembly includes a plurality of projections projecting out of each of said side pieces;
said second mating assembly includes a plurality of apertures in said tonneau cover; and
said projections on said side pieces are configured to be inserted through said apertures in said tonneau cover to releasably attached said tonneau cover to said frame.

5. The tonneau cover assembly of claim 4, wherein each of said projections is a twist lock.

6. The tonneau cover assembly of claim 1, wherein said opening in said tonneau cover is an open slot extending from the central section to a rear edge of said tonneau cover to permit selective adjustment of a position of the vertical hitch in the truck bed, such that said tonneau cover includes a base portion and two leg portions divided by said open slot.

7. The tonneau cover assembly of claim 6, further including a cable connecting end corners of said two leg portions.

8. The tonneau cover assembly of claim 1, wherein:
said frame includes a first cross piece and a second cross piece positioned perpendicular to and connecting said side pieces at respective ends of said side pieces, such that said first cross piece is positionable adjacent a rear of the truck bed and said second cross piece is positionable adjacent a front of the truck bed; and
said first cross piece and said second cross piece are configured to support said tonneau cover.

9. The tonneau cover assembly of claim 8, wherein:
said frame includes a third cross piece positioned perpendicular to and connecting said side pieces at a middle portion of each of said side pieces; and
said frame includes a pair of support pieces extending perpendicularly from said third cross piece to said first cross piece, such that said opening in said tonneau cover is positioned between said support pieces.

10. The tonneau cover assembly of claim 9, wherein:
said first cross piece includes a bent center portion positioned between said support pieces;
said bent center portion having a rectangular profile; and
said frame includes a support band connected to said side pieces and extending under and connected to said first cross piece at said bent center portion.

11. The tonneau cover assembly of claim 1, wherein said tonneau cover is flexible and configured to be rolled up.

12. The tonneau cover assembly of claim 5, wherein said opening in said tonneau cover is an open slot extending from the central section to a rear edge of said tonneau cover to permit selective adjustment of a position of the vertical hitch in the truck bed, such that said tonneau cover includes a base portion and two leg portions divided by said open slot.

13. The tonneau cover assembly of claim 12, further including a cable connecting end corners of said two leg portions.

14. The tonneau cover assembly of claim 13, wherein:
said frame includes a first cross piece and a second cross piece positioned perpendicular to and connecting said side pieces at respective ends of said side pieces, such that said first cross piece is positionable adjacent a rear of the truck bed and said second cross piece is positionable adjacent a front of the truck bed; and
said first cross piece and said second cross piece are configured to support said tonneau cover.

15. The tonneau cover assembly of claim 14, wherein:
said frame includes a third cross piece positioned perpendicular to and connecting said side pieces at a middle portion of each of said side pieces; and
said frame includes a pair of support pieces extending perpendicularly from said third cross piece to said first cross piece, such that said opening in said tonneau cover is positioned between said support pieces.

16. The tonneau cover assembly of claim 15, wherein:
said first cross piece includes a bent center portion positioned between said support pieces;
said bent center portion having a rectangular profile; and
said frame includes a support band connected to said side pieces and extending under and connected to said first cross piece at said bent center portion.

17. The tonneau cover assembly of claim 16, wherein said tonneau cover is flexible and configured to be rolled up.
